(19) United States
(12) Patent Application Publication
(10) Pub. No.: US 2008/0170251 A1
(43) Pub. Date: Jul. 17, 2008

(54) Method for transferring fax data multi-function peripheral using the same

(75) Inventors: Po-Yuan Chang, Tainan (TW); Chao-Yueh Hsiung, Taoyuan (TW); Hung-Wei Hsueh, Taichung (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 12/000,438

(22) Filed: Dec. 12, 2007

(30) Foreign Application Priority Data
Jan. 11, 2007 (TW) 96101150

(51) Int. Cl. G06F 3/12

(52) U.S. Cl. 358/1.13; 358/1.15

(57) ABSTRACT

A multi-function peripheral (MFP) including a fax receiving unit, a memory unit, a processing unit and a transmitting unit is provided. The fax receiving unit receives a fax data. The memory unit stores a transferring table. The processing unit recognizes an identification data from the fax data and obtains a corresponding communication data from the transferring table according to the identification data. The transmitting unit transfers the fax data according to the communication data.

This application claims the benefit of Taiwan application Serial No. 96101150, filed Jan. 11, 2007, the subject matter of which is incorporated herein by reference.

### BACKGROUND OF THE INVENTION

1. Field of the Invention

The invention relates in general to a method for transferring fax data and a multi-function peripheral (MFP) using the same, and more particularly to a method for transferring fax data to other electronic devices and a MFP using the same.

2. Description of the Related Art

Of the office appliances, conventional equipment having only one single function such as facsimile machine, scanner, printer, copier and so on are gradually replaced by multi-function peripheral (MFP) incorporating several functions in a machine. A MFP is capable of performing the work that used to be done by several machines. For example, an MFP can photocopy a document and further transmit the document via e-mail, and such function can not be achieved by a facsimile machine or a copy machine alone.

Currently, the receiving of fax data can only be done in a machine having fax receiving function. If the designated receiver is away from home or the office or is not around the facsimile machine, the fax data can not be delivered to the receiver immediately, and important information or message may be missed.

### SUMMARY OF THE INVENTION

The invention provides a method for transferring fax data and a multi-function peripheral (MFP) using the same. With the setting of transferring function on the multi-function peripheral, the fax data is transmitted to the receiver of the fax data via other communication applications.

According to a first aspect of the present invention, a method for transferring fax data is provided. The method includes the following steps. First, a fax data including an identification data is received. Next, the identification data is recognized. Then, a corresponding communication data is obtained from a transferring table according to the identification data. Then, the fax data is transferred to a destination according to the communication data.

According to a second aspect of the present invention, a multi-function peripheral (MFP) including a fax receiving unit, a memory unit, a processing unit and a transmitting unit is provided. The fax receiving unit receives a fax data including an identification data. The memory unit stores a transferring table including the identification data and a corresponding communication data of the identification data. The processing unit recognizes the identification data from the fax data and obtains a corresponding communication data from the transferring table according to the identification data. The transmitting unit transfers the fax data to a destination according to the communication data.

The invention will become apparent from the following detailed description of the preferred but non-limiting embodiments. The following description is made with reference to the accompanying drawings.

### BRIEF DESCRIPTION OF THE DRAWINGS

FIG. 1 is a functional diagram of a MFP of the invention;

FIG. 2 is a diagram of a fax data;

FIG. 3A is a block diagram of transferring the fax data of the invention;

FIG. 3B is another block diagram of transferring the fax data of the invention;

FIG. 4 is a flowchart of a method for transferring fax data of the invention; and

FIG. 5 is another flowchart of a method for transferring fax data of the invention.

### DETAILED DESCRIPTION OF THE INVENTION

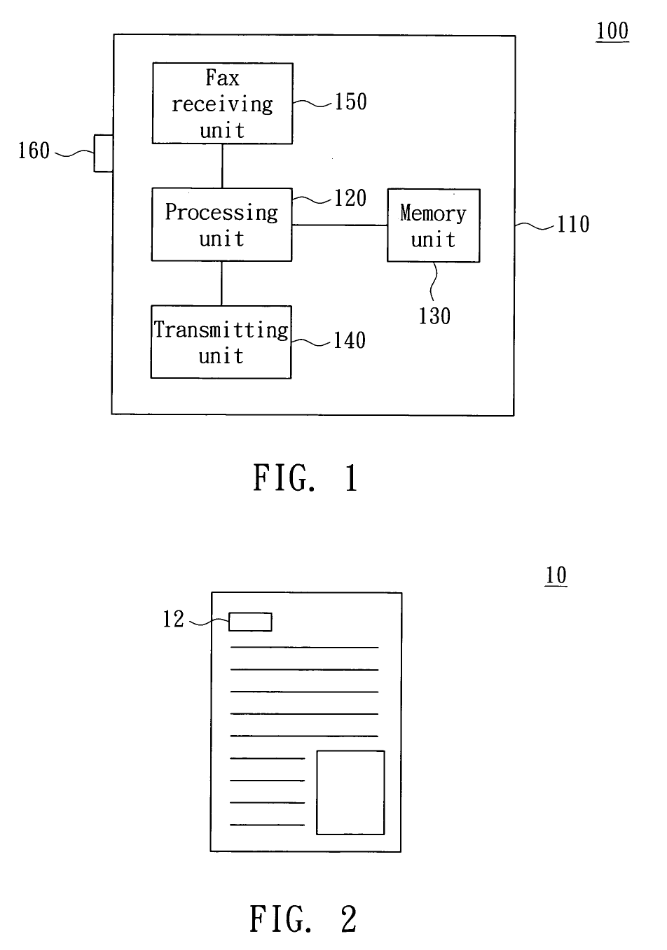

Referring to FIG. 1, a functional diagram of a multi-function peripheral (MFP) of the invention is shown. The MFP 100 includes a body 110, and a processing unit 120, a memory unit 130, a transmitting unit 140 and a fax receiving unit 150, wherein the memory unit 130, the transmitting unit 140 and the fax receiving unit 150 are all disposed inside the body 110. Referring to FIG. 2, a diagram of a fax data having an identification data 12 is shown. The fax receiving unit 150 receives a fax data 10. The processing unit 120 recognizes an identification data 12 from the fax data 10 according to the optical character recognition (OCR) technology. The identification data 12 may include one or several sets of name, identification number, employee number or a code for identifying a receiver of the fax data. The memory unit 130 stores a transferring table having an identification data 12 and a communication data corresponding to the identification data 12. The communication data is a telephone number or an e-mail address. After the processing unit 120 obtains a corresponding communication data of the identification data 12 from the transferring table according to the identification data 12, the transmitting unit 140, according to the communication data, transfers the fax data 10 to an electronic device that the fax receiver carries with him or in the vincinity of the fax receiver which is convenient for the fax receiver to obtain the fax data 10. Examples of the electronic device include mobile phone, personal digital assistant (PDA), facsimile machine, notebook computer, and any electronic devices enabling the fax receiver to conveniently obtain the fax data 10 are still within the spirit and scope of the invention.

The MFP 100 of the present embodiment of the invention further includes a setting switch 160 for setting the function of transferring the fax data 10 on or off. The setting switch 160 may be embodied by a mechanical or electrical switch element disposed inside or outside the body 110 or by a software-programmed function selection module. When the selection module is executed, the transferring function is turned on. Besides, the MFP 100 of the present embodiment of the invention further includes a personal communication data selection button (not illustrated). When there are several sets of personal communication data stored in the transferring table, the fax receiver can select a communication data with highest priority as the communication data obtained by the processing unit 120 according to the identification data 12. Also, the processing unit 120 can select one set from the sets of the communication data as a corresponding communication data of the identification data 12.

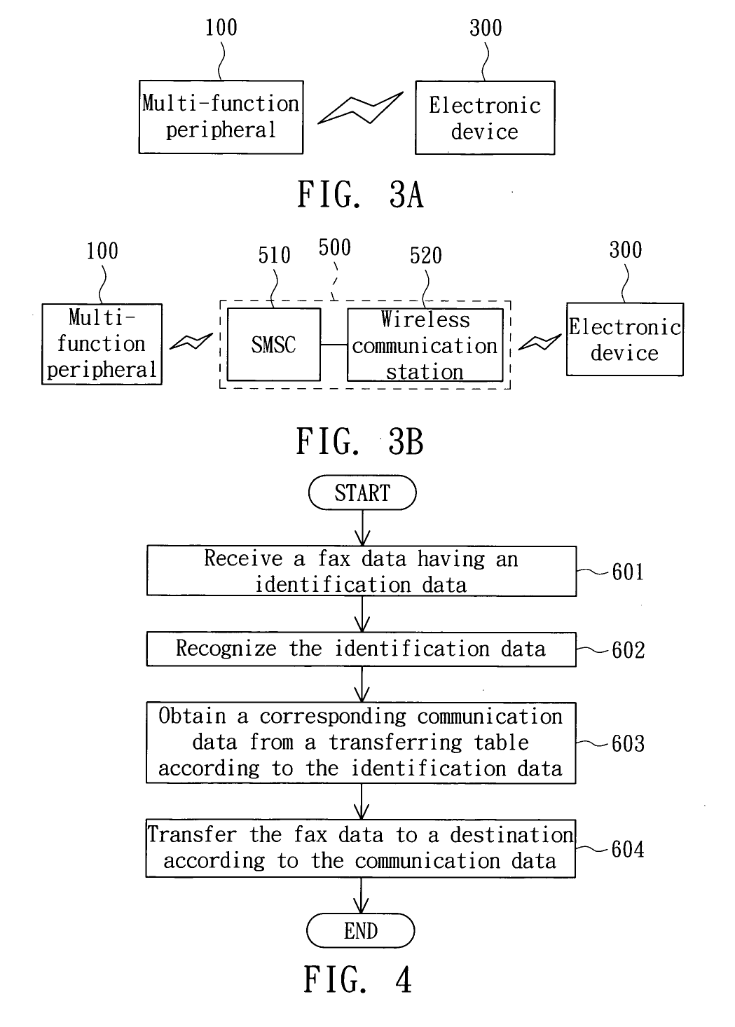

The block diagrams of the integrated system of the MFP 100 and the electronic device 300 are as illustrated in FIGS. 3A-3B. Also, referring to the reference numerals of FIG. 1. Referring to FIG. 3A, a block diagram of the invention for transmitting the fax data between the MFP 100 and the electronic device 300 is shown. If the electronic device 300 at the fax receiver end is a member of a local area network, then the transmitting unit 140 of the MFP 100 is a local area network unit. The MFP 100 may use the transmitting unit 140 to transfer the fax data 10 to an electronic device 300 supporting a corresponding wireless or cabled network transmission protocol via a wireless network transmission protocol such as IEEE 802.11a/b/g or a cabled network transmission protocol such as IEEE 802.3.

Also, referring to FIG. 3A. If the electronic device 300 at the fax receiver end and the MFP 100 are located within a short distance, the transmitting unit 140 of the MFP 100 can be a wireless transmission module such as a Bluetooth module or an infrared transmission module. The MFP 100 transfers the fax data 10 to the electronic device 300 using the transmitting unit 140, wherein the electronic device 300 is capable of receiving a signal from the Bluetooth module or the infrared transmission module.

Before the step of transmitting the fax data 10 to the destination, a security verification procedure can be performed by the MFP 100 first. If the fax data is approved in the security verification, the fax data is allowed to be transferred.

Referring to FIG. 3B, another block diagram of the invention for transmitting the fax data is shown. If the fax receiver fails to transfer the fax data by way indicated in FIG. 3A, the transmitting unit 140 of the MFP 100 can be an Internet unit such as a cabled network module or a wireless network module. The fax data 10 is transmitted to the Internet by the transmitting unit 140, stored in a short message service center (SMSC) 510 of a public land mobile network (PLMN) 500 for converting the fax data 10 in the form of a text message data or a picture to be transmitted to an electronic device 300 at the fax receiver end via a wireless communication station 520. The electronic device 300 at the fax receiver end is a mobile phone or any other electronic devices having a mobile communication module (such as PDA). However, the fax data 10 can also be transmitted to the Internet via e-mail, then the fax receiver receives the e-mail by the electronic device 300, hence obtaining the fax data 10. Here, the electronic device 300 for receiving the above e-mail is not limited to mobile phone or any electronic devices having a mobile communication module. Any electronic devices enabling the fax receiver to receive the above e-mail are still within the spirit and scope of the invention.

Likewise, referring to FIG. 3B, the transmitting unit 140 of the MFP 100 can also be a mobile communication module. The transmitting unit 140 directly transmits the fax data 10 in the form of a text message. If the fax data 10 further includes a picture, the fax data 10 is transmitted by way of multimedia messaging service (MMS). The electronic device 300 at the fax receiver end is a mobile phone or any other electronic devices having a mobile communication module (such as PDA).

The transmitting unit 140 of the MFP 100 can also be a fax module which transfers the fax data 10 to an electronic device 300 (such as a facsimile machine) neighboring the fax receiver by way of telephone line.

Referring to FIG. 4, a flowchart of a method for transferring fax data of the invention is shown. First, the method begins at step 601, a fax data including an identification data is received. The identification data is one or several sets of person name, identification number, employee number or any data enabling the identification of the fax receiver to be recognized.

Next, the method proceeds to step 602, the identification data is recognized according to the OCR technology.

Then, the method proceeds to step 603, a corresponding communication data is obtained from the transferring table according to the identification data. The communication data includes at least one of a telephone number and an e-mail address.

Afterwards, the method proceeds to step 604, the fax data is transferred to a destination according to the communication data.

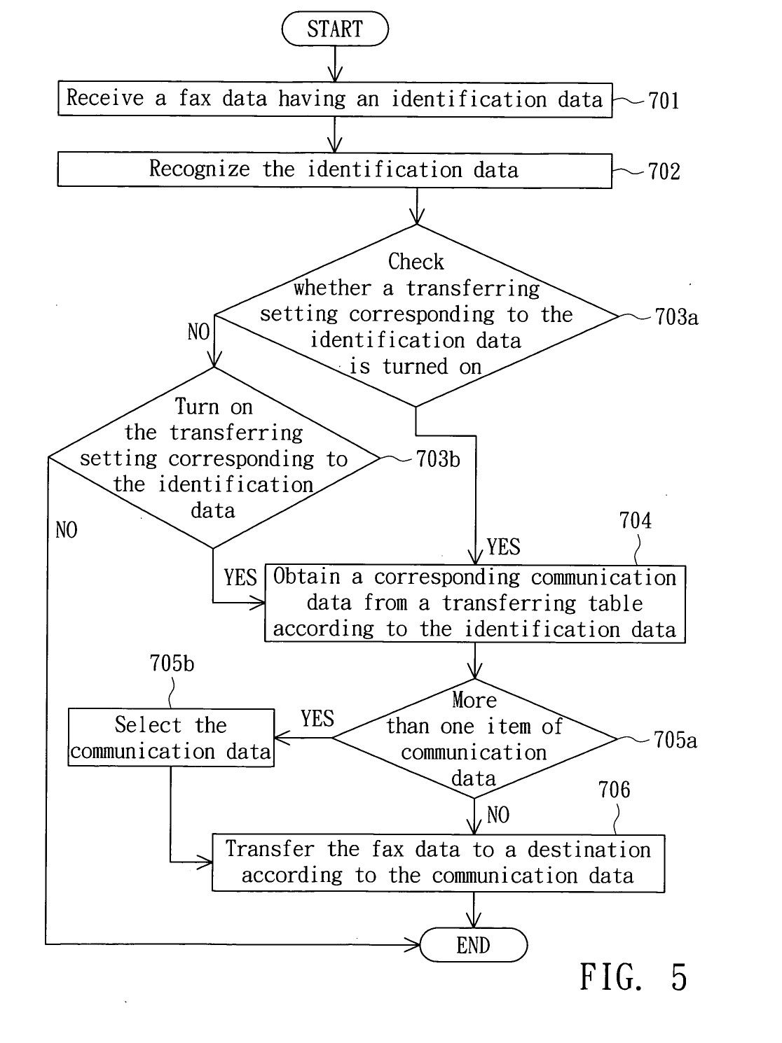

Referring to FIG. 5, another flowchart of a method for transferring fax data of the invention is shown.

First, the method proceeds to step 701, a fax data including an identification data is received. The identification data is one or several sets of person name, identification number, employee number or any data enabling the identification of the fax receiver to be recognized.

Next, the method proceeds to step 702, the identification data is recognized according to the OCR technology.

Then, the method proceeds to step 703a, whether a transferring setting corresponding to the identification data is turned on is checked. If the transferring setting corresponding to the identification data is turned on, then the method proceeds to the next step 704. If the fax receiver transferring function of the identification data is not yet turned on, then the method proceeds to step 703b, whether to turn on the transferring setting corresponding to the identification data is determined by a user near the device with fax data transferring function; or, if not any command is inputted within a pre-determined duration of time, then the transferring setting corresponding to the identification data is considered as being turned off. If the transferring setting corresponding to the identification data is turned on by the user near the device with fax data transferring function, then the method proceeds to the next step 704. If the user near the device with fax data transferring function does not turn on the transferring setting corresponding to the identification data, or no instruction is inputted within a pre-determined duration of time, then the transferring setting corresponding to the identification data is considered as being turned off, and the method is terminated.

If the identification data includes several sets of data having different fax receivers, then whether the transferring setting corresponding to each fax receiver is turned on is checked one by one, and the method proceeds to the step 703a.

Afterwards, the method proceeds to step 704, a corresponding communication data is obtained from the transferring table according to the identification data. The communication data includes at least a telephone number and an e-mail address.

After that, the method proceeds to step 705a, whether there is more than one set of communication data corresponding to the identification data stored in a transferring table is determined: if the identification data only corresponds to one set of communication data, then the method proceeds to the next step 706; otherwise, the method proceeds to the step 705b. In step 705b, at least one set of the communication data is pre-determined by the fax receiver or selected by the user operating the device with fax data transferring function; alternatively, the device with fax data transferring function can automatically select one or several sets of communication data.

Then, the method proceeds to step 706, the fax data is transferred to a destination according to the communication data.

In step 604 and 706, the method of transferring fax data further includes transferring the fax data via cabled or wireless transmission protocol, Bluetooth transmission protocol or infrared transmission as indicated in FIG. 3A, or transferring the fax data in the form of e-mail, text message or multimedia messaging service (includes a picture) via the Internet as indicated in FIG. 3B.

Before the fax data is transferred in step 604 and step 706, the method of transferring fax data as indicated in FIG. 3A further includes performing a security verification procedure such as inputting a valid verification data so as to obtain the authority for transferring the fax data within a short distance.

According to the method for transferring fax data and the MFP using the same disclosed in the above embodiment of the invention, the MFP is designed to have fax data transferring function. A corresponding communication data of the identification data is obtained from a pre-stored transferring table, and according to the communication data, the fax data is transferred to an electronic device convenient for the fax receiver to receive the same. Thus, the invention allows fax data to be transferred to an electronic device convenient for the fax receiver to receive the fax data when the fax receiver is outside or unable to be around the facsimile machine to receive the fax data immediately such that the fax receiver will not miss any fax.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-function peripheral (MFP) comprising:
a fax receiving unit for receiving a fax data;
a memory unit for storing a transferring table;
a processing unit for recognizing an identification data from the fax data and obtaining a corresponding communication data from the transferring table according to the identification data; and
a transmitting unit for transmitting the fax data to a destination according to the communication data.

2. The MFP according to the claim 1, wherein the identification data is a name, an identification number, an employee number or a code for identifying a receiver of the fax data.

3. The MFP according to the claim 1, wherein the communication data comprises at least one of a telephone number and an e-mail address.

4. The MFP according to the claim 1, wherein the transmitting unit is a mobile communication module and the fax data is transmitted to the destination in the form of a text message or a picture.

5. The MFP according to the claim 1, wherein the transmitting unit is a network unit.

6. The MFP according to the claim 5, wherein the fax data is transmitted to the destination in the form of a text message or e-mail.

7. The MFP according to the claim 1, wherein the transmitting unit is a wireless transmission module.

8. The MFP according to the claim 7, wherein the wireless transmission module is a Bluetooth module or an infrared transmission module.

9. The MFP according to the claim 7, wherein a security verification procedure is performed before the fax data is transmitted to the destination.

10. The MFP according to the claim 1, wherein the transmitting unit is a fax module.

11. The MFP according to the claim 1, further comprising a setting switch for turning the transferring function on or off.

12. A method for transferring fax data, comprising:
receiving a fax data comprising an identification data;
recognizing the identification data;
obtaining a corresponding communication data from a transferring table according to the identification data; and
transferring the fax data to a destination according to the communication data.

13. The method for transferring fax data according to the claim 12, wherein the identification data is a name, an identification number, an employee number or a code for identifying a receiver of the fax data.

14. The method for transferring fax data according to the claim 12, wherein the communication data comprises at least one of a telephone number and an e-mail address.

15. The method for transferring fax data according to the claim 12, wherein the step of transferring the fax data to the destination according to the communication data further comprises:
performing a security verification procedure.

16. The method for transferring fax data according to the claim 12, wherein the step of transferring the fax data to the destination according to the communication data further comprises:
transferring the fax data in the form of e-mail, a text message, a fax document or a picture.

17. The method for transferring fax data according to the claim 12, wherein the step of transferring the fax data to the destination according to the communication data further comprises:
transmitting the fax data via Internet, wireless or cabled transmission protocol, Bluetooth transmission protocol or infrared transmission.

18. The method for transferring fax data according to the claim 12, further comprising:
checking whether a transferring setting corresponding to the identification data is turned on so as to determine whether to transmit the fax data to the destination or not.

19. The method for transferring fax data according to the claim 18, further comprising:
providing a selection for turning on the transferring setting.

20. The method for transferring fax data according to the claim 19, further comprising:
turning off the transferring setting corresponding to the identification data if the command to turn on the transferring setting is not received within a pre-determined duration of time.

21. The method for transferring fax data according to the claim 12, further comprising:
obtaining at least one set of corresponding communication data from the transferring table according to the identification data.
